(19) United States
(12) Patent Application Publication
(10) Pub. No.: US 2004/0226872 A1
(43) Pub. Date: Nov. 18, 2004

(54) Apparatus for the purification of water

(75) Inventors: Leo Peter Wessels, Amersfoort (NL); Michel Riemersma, Amersfoort (NL); Walterus Gijsbertus Joseph Van der Meer, Sneek (NL)

Correspondence Address: PEACOCK MYERS AND ADAMS P C, P O BOX 26927, ALBUQUERQUE, NM, 871256927

(73) Assignees: DHV Water B.V., Leusden (NL); Vitens Friesland, Leeuwarden (NL)

(21) Appl. No.: 10/755,053

(22) Filed: Jan. 9, 2004

(30) Foreign Application Priority Data
Jul. 12, 2001 (NL) 1018527
Jul. 12, 2002 (WO) PCT/NL02/00464

(51) Int. Cl. C02F 1/42; C02F 1/44

(52) U.S. Cl. 210/190; 210/266

(57) ABSTRACT

An apparatus for purifying water, comprising an ion exchanger with a water inlet and a product outlet, connected to an inlet of a first filtration step, which comprises one or more nano- and/or RO-filtration membranes and is provided with a first permeate outlet and a first concentrate outlet. According to a first embodiment, the apparatus comprises a subsequent filtration step in which an inlet is connected with the first concentrate outlet, which subsequent filtration step comprises one or several subsequent nano- and/or RO-filtration membranes, and which is provided with a second permeate outlet and second concentrate outlet, which second concentrate outlet is optionally connected with an inlet of a subsequent filtration step.

The present invention relates to an apparatus for purifying water, comprising an ion exchanger with a water inlet and a product outlet, which product outlet is connected to an inlet of a first membrane filtration step, which comprises one or several nano- and/or RO-filtration membranes and is provided with a first permeate outlet and a first concentrate outlet.

Such an apparatus is known from the American patent U.S. Pat. No. 5,925,255. In such an apparatus the ion exchanger removes the bivalent positive or negative ions from the water to be purified, and replaces these with monovalent positive or negative ions. Since monovalent ions generally have a higher solubility product they will precipitate less readily. This is especially important for a subsequent membrane filtration step. When the bivalent positive or negative ions have been substantially replaced by monovalent ions, the concentration polarisation near the membrane surface can be considerably increased without the occurrence of precipitation. The yield of permeate per square meter of membrane surface, as well as the total yield (permeate obtained/supplied water) will increase considerably.

Due to the ion exchange as pre-treatment for the membrane installation, the increased permeate yield, as mentioned in U.S. Pat. No. 5,925,255 is no longer limited by precipitation of salts on the membrane but by hydraulic boundary conditions. This is because an increase in permeate yield per m² of membrane surface will result in greater hydraulic losses. At the same time, these hydraulic losses will cause the permeate production to be distributed very unevenly over the various, serially placed membranes.

It is the object of the invention to provide an improved apparatus of the technique mentioned in the preamble. To this end the invention provides an apparatus of the kind mentioned in the preamble, which is characterized in that the first membrane filtration step comprises at least two nano- and/or RO-filtration membrane elements placed in a pressure pipe and wherein the inlet is provided at external ends of the outer nano- and/or RO-filtration membrane elements and the first concentrate outlet is provided at a position between two elements flanking a central position, and wherein the apparatus comprises an optional subsequent membrane filtration step, wherein an inlet of said subsequent membrane filtration step is connected with the first concentrate outlet, which optional subsequent membrane filtration step comprises one of several subsequent nano- and/or RO-filtration membranes.

According to another preferred embodiment the invention provides an apparatus of the kind mentioned in the preamble, which is characterized in that the same comprises an optional subsequent filtration step in which an inlet is connected with the first concentrate outlet, which optional subsequent filtration step comprises one or several subsequent nano- and/or RO-filtration membranes and wherein the at least one membrane filtration step comprises at least two nano- and/or RO-filtration elements placed in a pressure pipe and wherein an inlet is provided at external ends of the outer nano- and/or RO-filtration membrane elements and a concentrate outlet is provided at a position between two elements flanking a central position.

It has now been shown that the permeate yield per square meter of membrane surface as well as the total yield can be further increased by limiting the hydraulic losses. Placing fewer membranes in series reduces the hudraulic losses. The result is that compared with the current systems, the increase in permeate yield is boosted. When, for example, two (or four, six, eight etc.) nano- filtration and or RO-filtration membrane elements are placed in a pressure pipe and the water is supplied at both sides of the pressure pipe while concentrate is being discharged from the middle, there is less pressure loss than when the water to be purified is supplied at a first side and concentrate is being discharged from the pressure pipe at the other side.

Systems that do not use an ion exchanger cannot be operated in this manner since the flow rate of the water to be purified along the membrane is too low, due to which there is too great a concentration polarisation. This will cause the precipitation of salts.

According to a general but particular preference, the nano- and/or RO-filtration membrane is formed by a capillary, a tubular, a spirally wound or plate-like membrane. Particularly preferred is the nano- and/or RO-filtration membrane in the form of a (semi-dead end) filtration membrane.

A particularly advantageous preferred embodiment is obtained by using a coupler between the various nano- and/or RO-filtration membranes, such as the one described in the European patent publication EP-0,925,825 (patent application number 98.204407.5). With this the flow resistance is particularly low, which results in smaller hydraulic losses and which results in a higher permeate yield.

As already mentioned, the concentrate from the nano- and/or RO-filtration membranes (first step) may be fed through to a subsequent purification step, which may consist of, for example, one or several nano- and/or RO-filtration membranes (reverse osmosis) (second step). Characteristically, a nano-filtration membrane has a relatively great permeate feed-through and a limited retention of ions. In contrast, a hyper-filtration membrane has the characteristic that the total permeate feed-through is less than with a nano-filtration membrane, whereas in contrast, the retention of ions is higher. By feeding the concentrate from the nano- and/or RO-filtration membranes of the first step to one or several RO-filtration membranes in the second step, a permeate of a higher purity is obtained than when in the second step nano-filtration membranes are being used.

In one preferred method therefore the concentrate from the first membrane filtration step is fed through to one or several subsequent membrane filtration steps.

According to the invention, the flow rate of water to be purified along the membrane surface may be relatively low because due to the substantial absence of bivalent positive or negative ions, the concentration polarisation does not need to be maintained at so low a level as with the technique currently in use.

Incidentally, in the art RO-filtration is generally also termed hyperfiltration.

In accordance with a preferred embodiment biofouling is prevented by feeding regenerate along the surface of the membranes prior to being fed to the ion exchanger in order to cause the biofouling present to die off.

It is also possible to combat and prevent biofouling in a nano- and/or RO-filtration membrane installation (NF/RO-installation) by periodically exchanging the steps and/or pressure pipes (comprising the NF/RO-membranes) in the filtration installation. Preferably the apparatus is provided with a control for periodically changing this flow-through sequence of the filtration steps. Biofouling occurs in the first elements of the series. By changing the flow-trough sequence with the aid of valves (and by suitably embodying the entire pipe system of the installation) it is possible to change the sequence of the elements. This has the advantage that it enables relatively high salt concentrations to contribute to the cleaning of the elements. The advantages of this kind of cleaning as opposed to cleaning with regenerate from the ion exchanger or otherwise with a saline solution are:

uninterrupted operation;

a reasonable first filtrate because there are no high salt concentrations at the feed side of the membrane when restarting after cleaning.

Preferred is an installation in which the membrane filtration system consists of several steps, each separately placed in so-called stacks. The flow-through sequence of the stacks may be changed periodically whereby after a certain period of operation a stack from the first step is exchanged with a stack that was previously placed in the second step.

After some time the ion exchanger will comprise a large amount of bivalent positive or negative ions that have been captured from th water to be purified. The regenerate formed during regeneration of the ion exchanger as waste stream, here has a concentration of bivalent positive or negative ions, which during production are adsorbed on the resin, and of parts of the regeneration agent (such as NaCl, HCl and NaOH). The bivalent positive or negative ions can be separated out of the regeneration liquid.

According to a first aspect it is preferred for the regenerate from the ion exchanger to be treated in a ((semi-) dead-end) nano-filtration unit, an electrodialyser or the like, in order to substantially remove bivalent ions. The permeate thus obtained may after, for example, the addition of regeneration agent be reused for a subsequent regeneration of the ion exchanger. According to a second aspect, the used regenerate from the ion exchanger is treated by adding a precipitation agent, preferably soda (Na₂CO₃). This will cause the greater part of all the bivalent positive ions to precipitate with the added carbonate: after sedimentation and an acid addition to the clarified water the thus treated regenerate may, optionally after a particle filtration, be reused for regenerating the ion exchanger anew. Alternatively, the regenerate may fist be fed to a surge tank and subsequently to the ion exchanger for regeneration. This allows the regeneration agent that was left in the regenerate and the water to be reused.

According to another preferred embodiment, the regenerate from the ion exchanger together with the concentrate from the final filtration step are fed to a precipitation tank in order to allow at least part of the contaminants to precipitate in the form of salts. The liquid from the precipitation tank from which at least part of the contaminants have been removed is then fed to a nano- and/or RO-filtration unit or an electrodialyser in order to substantially remove remaining bivalent positive or negative ions from this liquid and to discharge them into a concentrate stream, which is optionally fed back to the precipitation tank, while p rmeate from this nano- and/or RO-filtration unit or the like is reused as regeneration liquid. This makes it possible to use water and regeneration chemicals in an extremely economical manner. The use of regeneration agent is kept to a minimum. Preferably the precipitation tank comprises a seed material. This vastly improves the precipitation of salts thanks to the ample availability of precipitation surface. The solid salts may be separated out and may after an optional treatment be reused.

This is a great advantage in comparison with the system described in the American patent U.S. Pat. No. 3,639,231, in which the concentrate from the RO-filtration is used for the regeneration of the ion exchanger, while a considerable waste stream (the regenerate from the regeneration of the ion exchanger) is produced. Recovery of water and chemicals from regenerate and/or concentrate according to the above-mentioned techniques may generally be applied to the regenerate from a separately provided ion exchanger or from a separately provided membrane filtration installation.

The invention will now be further elucidated with reference to a number of figures.

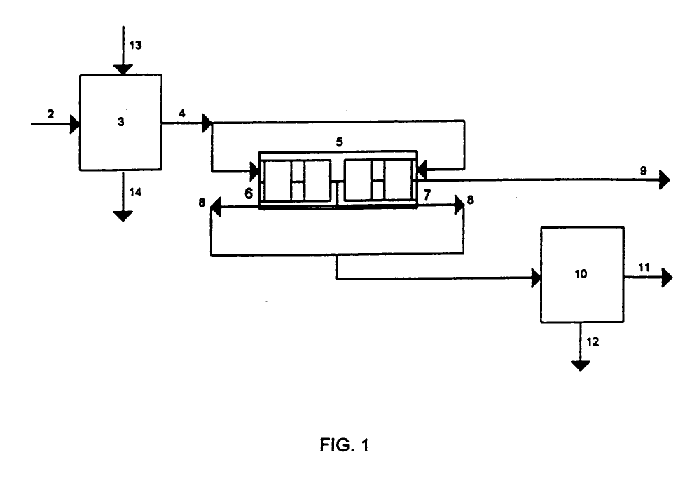

FIG. 1 shows an apparatus according to the invention.

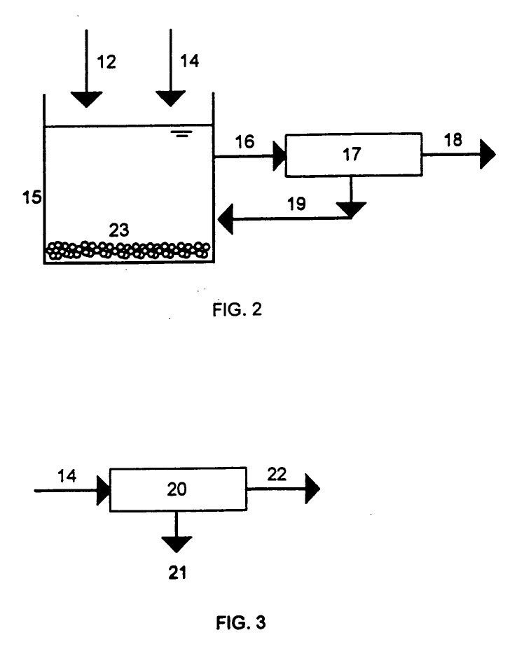

FIG. 2 shows an apparatus for recycling the regenerate and concentrate according to the invention.

FIG. 3 shows an apparatus for recycling the regenerate.

Identical reference numbers used in the various figures have identical meanings.

The apparatus 1 for the purification of water, as shown in FIG. 1, comprises an inlet 2 to an ion exchanger 3. In this ion exchanger bivalent ions, or possibly only bivalent cations or only bivalent anions that are present in the feed are removed. These are exchanged for the monovalent ions present in the ion exchanger. The product 4 from the ion exchanger 3 is fed to a nano- and/or RO-filtration membrane comprised in a pressure pipe 5. The pressure pipe 5 forms a first filtration step. The product 4 is fed to the pressure pipe 5 at two ends 6, 7, concentrate 8 is discharged at the ends of the pressure pipe 5. As shown in the figure, there is a total of four membrane filter elements, but the product 4 always only passes through two membrane filter elements. Another number of at least two, and preferably an even number such as four, six, etc. filter elements is of course also possible. The product then passes through one, two, three, etc. filter elements, respectively. This considerably reduces the total flow resistance. The permeate formed here is discharged via a permeate outlet 9. This may be provided at one end or at two ends. The concentrate 8 is fed to one or several nano- and/or RO-filtration membranes 10 (second step). Compared with the product 4, the concentrate 8 has an elevated ion content, which may conveniently be separated by means of hyperfiltration membranes. The substantially ion-free permeate 11 may optionally be fed to a subsequent RO-membrane filtration module, depending on the degree of purity desired.

After some time the ion exchanger 3 will be loaded with bivalent positive or negative ions. In order to remove these bivalent ions originating from the water to be purified 2, a regeneration agent 13 is added, which replaces the bivalent ions with monovalent ions. This regeneration agent may contain, for example, sodium chloride, HCl a NaOH. The regenerate 14 produced contains a high concentration of bivalent ions, for example, calcium, barium, iron, manganese and sulphate ions, as well as monovalent ions (e.g. Na⁺, H⁺, Cl⁻, OH⁻) that are present in the original regeneration agent. It is particularly preferred for the operations to be conducted anaerobically. If the regenerate contains oxygen, the said bivalent positive ions, especially manganese and iron, will oxidise and precipitate. In order to avoid any presence of oxygen, it is specially preferred for the entire apparatus to be operated anaerobically, which means that both the water to be purified and the regeneration liquid are anaerobic. Preferably therefore, the water inlet of the ion exchanger is connected with a source of anaerobic water.

According to a preferred embodiment, as shown in FIG. 2, the regenerate 14 and the concentrate 12 are fed to a precipitation tank 15. In the precipitation tank both liquid streams 12, 14 are mixed and optionally contacted with a seed material. A large part of the bivalent positive or negative ions in the liquid feed streams 12, 14 will precipitate as solid 23. Liquid 16 from which bivalent positive or negative ions have substantially been removed is fed to a filtration module 17, which may preferably comprise a nano- and/or RO-filtration membrane, which may be operated either in the semi-dead end or cross-flow technique. In this way particularly the remaining bivalent ions will be separated out, producing a permeate stream 18, which comprises substantially water and monovalent ions, and a concentrate stream 19, which comprises water and bivalent ions and which can be returned to the precipitation tank 15. After admixing the respective chemicals, the permeate stream 18 may be reused as regeneration liquid 13 for regenerating the ion exchanger 3.

According to another embodiment the regenerate 14 is fed to a nano- and/or RO-filtration membrane module, preferably a semi-dead end nanofiltration membrane module or ED(R) ((reversed) electrodialyser) 20, as shown in figure 3, in order to remove the bivalent ions from the regenerate 14. This concentrate may subsequently be discharged and after admixing the respective chemicals, the permeate 22 produced may be reused as regeneration liquid 13 for the regeneration of the ion exchanger 3.

The present invention provides a number of significant advantages. The total water production is very high. In accordance with a preferred embodiment of the invention, the captured bivalent ions can be discharged from the precipitation tank in the form of solids. The possibility for passing regeneration agent over the filtration membrane greatly reduces the chance of biomass fouling. An additional advantage of the invention is that due to the capture of bivalent ions, the concentration polarisation is allowed to be very high, making it possible to apply low flow rates. This provides the apparatus according to the invention with a high hydraulic effectiveness.

In the apparatus according to the invention the concentration polarisation may be greater than usual (>1.5 compared with <1.2). As a consequence no or nearly no chemicals (acid and anti-scalants) are needed to prevent scaling.

The total permeate throughput is approximately 40-60 l/m²h or even higher, while currently in the art maximum yields of 20-30 l/m²h are feasible. The total yield of permeate (amount of permeate/supply first membrane filtration step) exceeds 93%. This is considerably higher than up to now possible in the art.

The increase in permeate throughput means that fewer membrane elements are required. This results in significant savings in costs. Due to the fact that no chemicals are needed to prevent scaling and biofouling, the membranes are not exposed to the usual acids, bases, and other cleaning agents, such as, for example chlorine compound and will therefore be useable for a longer period of time. An optional suitable final treatment of the regenerate 14 and the concentrate 12 makes it possible to obtain salts in pure form.

The figures merely serve to describe a preferred embodiment of the invention. A person skilled in the art will easily be able to perform other applications, which all fall under the general concept of the invention.

What is claimed is:

1. An apparatus for purifying water, comprising an ion exchanger with water inlet and a product outlet, which product outlet is connected to an inlet of a first membrane filtration step, which comprises one or several nano- and/or RO-filtration membranes and is provided with a first permeate outlet and a first concentrate outlet, wherein the first membrane filtration step comprises at least two nano- and/or RO-filtration membrane elements placed in a pressure pipe and wherein the inlet is provided at external ends of the outer nano- and/or RO-filtration membrane elements and the first concentrate outlet is provided at a position between two elements flanking a central position.

2. An apparatus according to claim 1, wherein the water inlet of the ion exchanger is connected with a source of anaerobic water.

3. An apparatus according to claim 1, wherein the apparatus further comprises a precipitation tank wherein an inlet of said precipitation tank is connected with a regenerate outlet from the ion exchanger; as well as an inlet for a precipitation agent, preferably NA₂CO₂ to be added to the regenerate; and wherein an outlet of regenerate from the precipitation tank is connected with an inlet for regeneration liquid to the ion exchanger.

4. An apparatus according to claim 1, wherein the regenerate from the ion exchanger is treated in a nano-filtration unit, an electrodialyser or the like, in order to substantially remove bivalent ions, and the permeate thus obtained is reused for a subsequent regeneration of the ion exchanger.

5. An apparatus according to claim-1, wherein prior to being fed to the ion exchanger, regeneration liquid for the ion exchanger is fed along the surface of the nano- and/or RO-filtration membranes.

6. An apparatus according to claim 1, wherein the apparatus is provided with a control for periodically changing the flow-through sequence of the filtration steps.

7. An apparatus according to claim 1, wherein the apparatus further comprises a separator, wherein an inlet of said separator is connected with a final concentrate outlet and with a regenerate outlet from the ion exchanger, which separator is equipped to substantially separate bivalent ions from liquid streams fed to the separator.

8. An apparatus according to claim 1, wherein regenerate from the ion exchanger and the concentrate from the final membrane filtration step are fed to a precipitation tank in order to allow at least a part of the bivalent ions to precipitate, the liquid from the precipitation tank from which at least part of the bivalent ions have been removed is fed to a nanofiltration unit, an electrodialyser or the like, in order to substantially remove bivalent ions present in this liquid into a concentrate stream, which concentrate stream is optionally fed back to the precipitation tank, while permeate from this nanofiltration unit or the like is reused for the regeneration of the ion exchanger.

9. An apparatus according to claim 1, wherein the nano- and/or RO filtration membrane is a capillary, a tubular, a spirally wound or plate-like membrane.

10. An apparatus according to claim 1, wherein the nano- and/or RO-filtration membrane is a dead-end filtration membrane.

11. An apparatus according to claim 1, wherein the precipitation tank comprises a seed material.

12. An apparatus according to claim 1, additionally comprising a subsequent membrane filtration step, wherein an inlet of said subsequent membrane filtration step is connected with the first concentrate outlet, which subsequent membrane filtration step comprises one or several subsequent nano- and/or RO-filtration membranes and is configured like the first membrane filtration step.

13. An apparatus according to claim 3, additionally comprising an intermediate surge tank.
